(19) United States
(12) Patent Application Publication
(10) Pub. No.: US 2015/0160156 A1
(43) Pub. Date: Jun. 11, 2015

(54) CASSETTE FOR ELECTROPHORESIS AND ELECTROPHORESIS METHOD

(71) Applicant: Sharp Kabushiki Kaisha, Osaka-shi, Osaka (JP)

(72) Inventors: Mieko Otonashi, Osaka-shi (JP); Hideki Kinoshita, Osaka-shi (JP); Yutaka Unuma, Osaka-shi (JP); Yuji Maruo, Osaka-shi (JP)

(21) Appl. No.: 14/405,165

(22) PCT Filed: Jun. 4, 2013
(86) PCT No.: PCT/JP2013/065422

§ 371 Date: Dec. 3, 2014

(30) Foreign Application Priority Data
Jun. 4, 2012 (JP) 2012-127572

(51) Int. Cl. G01N 27/447

(52) U.S. Cl. CPC G01N 27/447

(57) ABSTRACT

To easily introduce a sample into a sample separation medium without formation of a well in the sample separation medium, a cassette (100) for electrophoresis includes a porous member (132) containing an unseparated sample, a sample separation medium (112) for separating the sample, and a pushing tool (131) that presses the porous member (132) or the sample separation medium (112) so that the porous member (132) is pushed into the sample separation medium (112).

### TECHNICAL FIELD

The present invention relates to a cassette for electrophoresis and an electrophoresis method.

### BACKGROUND ART

An electrophoresis method has been known as a method for separating a biospecimen. The electrophoresis method is a method for separating a separation subject sample, such as a protein or a nucleic acid, based on a difference in moving speed during electrophoresis. In particular, a typical method separates a sample by introducing the sample into a gel containing an electrolyte and applying a voltage to both ends of the gel.

A widely known method for separating a protein is electrophoresis using a polyacrylamide gel in the presence of sodium dodecyl sulfate (SDS) (hereinafter, referred to as “SDS-PAGE”). In SDS-PAGE, a protein and SDS having a negative charge form a composite with a constant ratio, and by applying a voltage to both ends of the gel, the protein-SDS composite moves in the polyacrylamide gel toward the positive electrode. At this time, the protein is separated on the basis of molecular weight by molecular sieving effect of the polyacrylamide gel.

NPL 1 describes formation of a gel for SDS-PAGE by pouring an acrylamide solution into a space formed by two flat glass plates or resin plates and spacers arranged between the plates, inserting a comb for forming recessed portions (wells) for sample application, and polymerizing the acrylamide solution in a container.

NPL 1 also describes formation of a separation gel for separating a sample protein and a concentration gel for concentrating the sample protein, by preparing acrylamide solutions with different concentrations and discontinuously polymerizing the acrylamide solutions in the container.

Also, PTL 1 describes a new method for preparing a support gel for electrophoresis, a supporting base, and an electrophoresis method. PTL 1 describes a gel for electrophoresis having a sample arranging portion being formed of a wedge-type recessed portion, and a container for forming the gel.

Also, in recent years, forming plural separation gels and concentration gels having interfaces with the same length needs some experiences, and polymerization of gels takes a time. Hence, demand of a commercially available precast gel cassette previously filled with a gel is increasing.

The commercially available precast gel cassette includes two flat glass or resin plates, and a space between the two plates is filled with a gel. Also, the gel has wells formed for introducing a sample solution into the separation gel. A user injects a sample solution that the user wants to separate to the wells, and starts an experiment of electrophoresis.

### CITATION LIST

### Patent Literature

PTL 1: Japanese Unexamined Patent Application Publication No. 2004-45107 (published on Feb. 12, 2004)
PTL 2: Japanese Patent Application No. 2005-252755 (published on Aug. 31, 2005)

### Non Patent Literature

NPL 1: Edited by Japanese Electrophoresis Society, “Saishin Denki Eido Jikkenho,” Ishiyaku Pub., Inc., (issued in February, 1992)

### SUMMARY OF INVENTION

### Technical Problem

Regarding the gel for electrophoresis according to related art, to form the wells, a mold called comb is used, and the wells are formed in the gel by removing the comb before electrophoresis. At this time, in the work of removing the comb from the gel, the shapes of the wells may be collapsed, a crack may be generated, and the air may enter the gel. Therefore, the comb has to be removed very carefully.

Also, when the sample solution is applied to the wells, the air has to be prevented from entering the gel and the tip of a pipette tip has to be prevented from sticking into the gel with utmost caution.

Further, the shapes of the wells and the work of applying the sample solution to the wells affect the result of electrophoresis, and hence these are important matters. However, since the gel is a soft elastic body, it is difficult to form wells having uniform shapes with good reproducibility. Also, the gel may be likely deformed when the comb is removed from the gel as described above. Owing to these problems, it takes a time to achieve a precise work in current situations.

Also, in related art, to carry out electrophoresis for an unseparated sample, wells have to be formed in a sample separation medium. Hence, it is difficult to avoid the above-described problems. PTL 2 describes introduction of a sample separated by first-order electrophoresis into a gel for second-order electrophoresis, without formation of a well, by bringing a gel after the first-order electrophoresis into contact with the gel for second-order electrophoresis. However, this is a technology of introducing a separated sample into a sample separation medium, and this is not a technology of introducing an unseparated sample into a sample separation medium.

The present invention is made to address the problems, and a major object of the invention is to provide a technology of introducing an unseparated sample into a sample separation medium without formation of a well in the sample separation medium.

### Solution to Problem

To address the above-described problems, a cassette for electrophoresis according to the invention includes a porous member containing an unseparated sample; a sample separation medium for separating the sample; and a pushing tool that presses the porous member or the sample separation medium so that the porous member is pushed into the sample separation medium.

With the configuration, the pushing tool presses the porous member toward the sample separation medium and pushes the porous member into the sample separation medium; or the porous member is attached to the pushing tool and the porous member is pushed into the sample separation medium together with the pushing tool. Hence, the porous member containing the unseparated sample can be inserted into the sample separation medium. Accordingly, the unseparated sample can be introduced into the sample separation medium from the position at which the porous member is inserted. Therefore, the unseparated sample can be introduced into the sample separation medium without formation of a well, and the unseparated sample can be introduced to a target position at a target timing. Hence, as compared with a case in which the unseparated sample is introduced through a well, the unseparated sample does not diffuse into the sample separation medium, and high resolution can be obtained during electrophoresis.

The cassette for electrophoresis according to the invention may preferably further include an auxiliary tool arranged on the sample separation medium and being in close contact with the sample separation medium. The auxiliary tool may preferably have a through hole that allows the porous member and the pushing tool to be inserted to the sample separation medium.

With the configuration, since the through hole that allows the porous member and the pushing tool to be inserted to the sample separation medium is provided, the porous member can be pushed into the sample separation medium through the through hole.

The cassette for electrophoresis according to the invention may preferably further include an insulator that houses the sample separation medium while a portion of an upper surface of the sample separation medium is exposed. Also, the auxiliary tool may be preferably fitted to the insulator and be in close contact with the exposed portion of the sample separation medium.

With the configuration, the sample separation medium can be housed in the insulator, and electrophoresis can be carried out like normal slab electrophoresis or the like.

In the cassette for electrophoresis according to the invention, the auxiliary tool may preferably include a first contact portion, the pushing tool may preferably include a second contact portion, and the first contact portion and the second contact portion may preferably contact each other and stop movement of the porous member in a case in which the porous member is pushed into the sample separation medium by a predetermined length.

With the configuration, even if the porous member is strongly pushed into the sample separation medium, the first contact portion and the second contact portion contact each other and stop the movement of the porous member when the porous member is pushed into the sample separation medium by the predetermined length. Hence, the pushing length when the pushing tool and the porous member are pushed into the sample separation medium can be normally constant. Accordingly, the pushing tool and the porous member are prevented from excessively entering the sample separation medium, the result of electrophoresis of the unseparated sample can be prevented from being disordered, and analysis resolution can be increased.

In the cassette for electrophoresis according to the invention, a hollow portion may be formed at side surfaces of the pushing tool, and the porous member may be arranged in the hollow portion.

With the configuration, since the porous member is arranged in the pushing tool, even if a time elapses before electrophoresis is carried out, the porous member does not contact the sample separation medium unless the porous member is pushed into the sample separation medium. Accordingly, the unseparated sample can be prevented from diffusing into the sample separation medium before the porous member is pushed into the sample separation medium.

In the cassette for electrophoresis according to the invention, a sharp portion protruding toward the sample separation medium may be formed at a tip end portion of the pushing tool.

With the configuration, since the sharp portion of the pushing tool contacts the sample separation medium when the pushing tool presses the sample separation medium, gas such as the air can be prevented from entering the close contact surfaces of the sample separation medium and the pushing tool.

In the cassette for electrophoresis according to the invention, the porous member may be attached to a tip end portion of the pushing tool.

With the configuration, the porous member can be appropriately pushed into the sample separation medium by the pushing tool.

In the cassette for electrophoresis according to the invention, the porous member may be preferably made of a substance selected from a group consisting of resin, filter paper, an agarose gel, and a glass filter.

With the configuration, the porous member can appropriately contain the unseparated sample, and the sample can be appropriately introduced from the porous member into the sample separation medium. Also, even if the substance is inserted into the sample separation medium, the substance hardly affects electrophoresis.

In the cassette for electrophoresis according to the invention, the porous member may be preferably hydrophilized.

With the configuration, the porous member can further appropriately contain the unseparated sample, and the sample can be further appropriately introduced from the porous member into the sample separation medium.

In the cassette for electrophoresis according to the invention, the sample separation medium may be preferably made of a gel.

With the configuration, since the sample separation medium is soft, the porous member can be successfully pushed into the sample separation medium by the pushing tool. Also, electrophoresis can be appropriately carried out.

The cassette for electrophoresis according to the invention may include a plurality of the porous members. The pushing tool may include a plurality of pushing portions that respectively push the plurality of porous members into the sample separation medium.

With the configuration, the plurality of porous members containing unseparated samples can be simultaneously pushed into the sample separation medium, and the samples in the plurality of porous members can be simultaneously brought into electrophoresis.

An electrophoresis method according to the invention includes a pushing step of pressing a porous member containing an unseparated sample or a sample separation medium for separating the unseparated sample by using a pushing tool so that the porous member is pushed into the sample separation medium; and an electrophoresis step of carrying out electrophoresis for the unseparated sample which has been moved from the pushed porous member to the sample separation medium.

With the configuration, advantageous effects similar to those of the cassette for electrophoresis according to the invention can be attained.

The electrophoresis method according to the invention may further include an applying step of, while an auxiliary tool being in close contact with the sample separation medium and having a through hole that allows the porous member to be inserted to the sample separation medium is arranged on the sample separation medium, applying a sample solution containing the unseparated sample to the through hole before the pushing step; and a sample introducing step of causing the porous member to contain the unseparated sample by inserting the porous member into the through hole applied with the sample solution after the applying step and before the pushing step.

With the configuration, the sample solution containing the unseparated sample is applied to the through hole provided at the auxiliary tool. Also, by inserting the porous member into the through hole applied with the sample solution, the unseparated sample can be successfully contained in the porous member. Accordingly, the sample can be easily introduced into the porous member without an additional operation for introducing the sample into the porous member.

The electrophoresis method according to the invention may further include an injecting step of injecting a sample solution containing the unseparated sample into a sample introducing container before the pushing step; and a sample introducing step of causing the porous member to contain the unseparated sample by inserting the porous member into the sample introducing container containing the sample solution after the injecting step and before the pushing step.

With the configuration, by inserting the porous member into the sample introducing container having the sample solution, the unseparated sample can be easily introduced into the porous member.

In the electrophoresis method according to the invention, agarose may be put into the sample introducing container in the injecting step, and the agarose in the sample introducing container may be heated and molten in the sample introducing step.

With the configuration, by heating and melting the agarose put into the sample introducing container, the agarose can be dissolved in the sample solution. Accordingly, when the unseparated sample is contained in the porous member, the agarose can be also contained. Since the agarose is solidified in the porous member, the unseparated sample can be prevented from moving to the outside from the porous member before the pushing step. Hence, the unseparated sample can be efficiently introduced into the porous member.

### Advantageous Effects of Invention

With the invention, the cassette for electrophoresis that can easily introduce the sample into the sample separation medium without formation of a well at the sample separation medium, and a technology relating to the cassette for electrophoresis can be provided.

### BRIEF DESCRIPTION OF DRAWINGS

FIG. 1 is a perspective view schematically showing a configuration of a cassette for electrophoresis according to an embodiment of the invention.

FIG. 2 is a cross-sectional view schematically showing the configuration of the cassette for electrophoresis according to the embodiment of the invention.

In FIG. 3, part (a) is a perspective view schematically showing a configuration of a sample separation unit according to the embodiment of the invention, and part (b) is a perspective view schematically showing the configuration of the sample separation unit when an auxiliary tool is removed according to the embodiment of the invention.

FIG. 4 is a perspective view schematically showing a configuration of a cassette for electrophoresis according to another embodiment of the invention.

FIG. 5 provides enlarged views each showing a variation of a pushing tool and a porous member containing an unseparated sample according to the embodiment of the invention.

FIG. 6 provides enlarged views each showing a different variation of a pushing tool and a porous member containing an unseparated sample according to the embodiment of the invention.

FIG. 7 provides enlarged views each showing a variation of a pushing tool and a porous member containing an unseparated sample according to the other embodiment of the invention.

FIG. 8 provides schematic illustrations each showing a method of introducing an unseparated sample into a porous member.

FIG. 9 provides schematic illustrations each showing a method of pushing a porous member containing an unseparated sample into the sample separation medium according to the embodiment of the invention.

FIG. 10 provides schematic illustrations each showing another method of pushing a porous member containing an unseparated sample into the sample separation medium according to the embodiment of the invention.

### DESCRIPTION OF EMBODIMENTS

Embodiments of the invention are described below in detail.

### First Embodiment

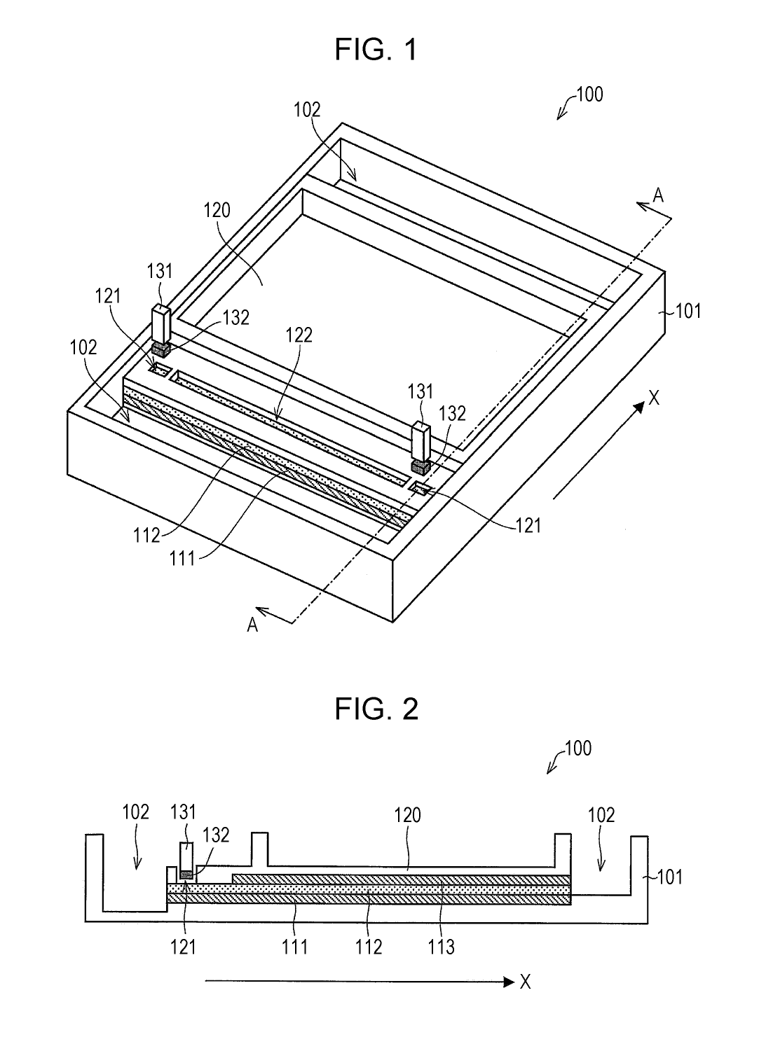

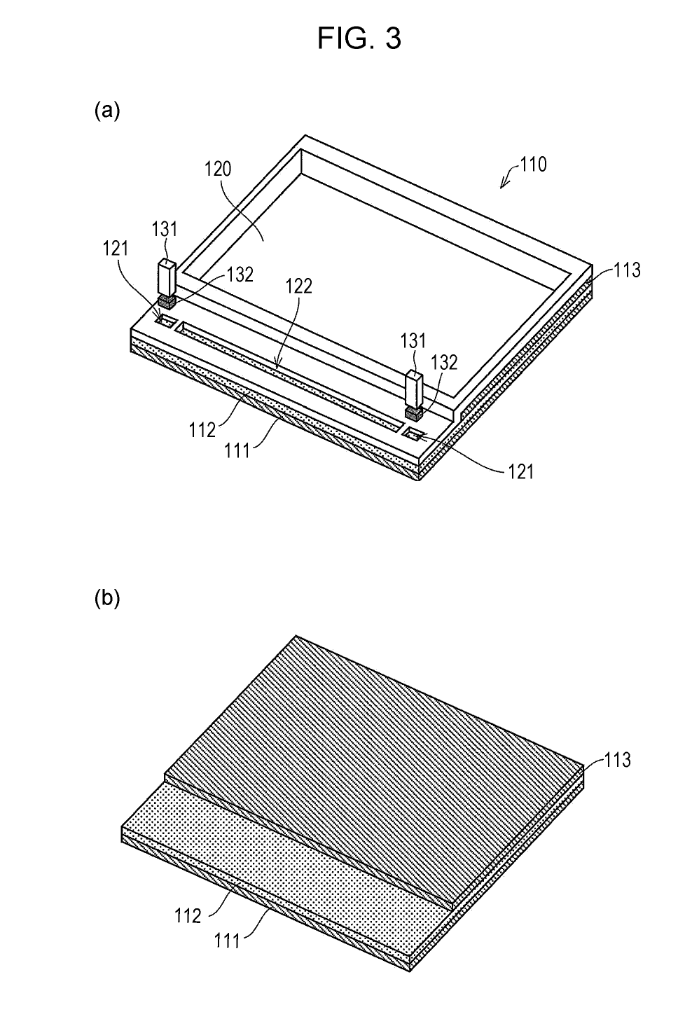

A first embodiment of the invention is described in detail with reference to FIGS. 1 and 2. FIG. 1 is a perspective view schematically showing a configuration of a cassette for electrophoresis according to the embodiment of the invention. FIG. 2 is a cross-sectional view taken along arrow A-A in FIG. 1.

### (Cassette for Electrophoresis)

A cassette 100 for electrophoresis according to the embodiment of the invention is removably installed in an electrophoresis apparatus that separates a separation subject sample, such as a protein or a nucleic acid, and/or a control sample, based on a difference in moving speed during electrophoresis.

As shown in FIG. 1, the cassette 100 for electrophoresis includes a buffer cell 101, an electrophoresis buffer solution reservoir 102, sample separation medium support plates (insulators) 111 and 113, a sample separation medium 112, an auxiliary tool 120, a porous member 132 containing an unseparated sample, and a pushing tool 131.

The buffer cell 101 houses a sample separation unit 110. By housing the sample separation unit 110 in a center portion of the buffer cell 101, electrophoresis buffer solution reservoirs 102 are formed at both sides of the buffer cell 1-1.

The two electrophoresis buffer solution reservoirs 102 formed at both sides are each a liquid reservoir to be filled with a buffer solution that is used for electrophoresis. The electrophoresis buffer solution reservoirs 102 form a pair and sandwiches the sample separation unit 110.

In the cassette 100 for electrophoresis, the electrophoresis buffer solution reservoirs 102 are filled with the buffer solution, electrodes and the like are arranged at the buffer solution reservoirs, and a voltage is applied between the two electrophoresis buffer solution reservoirs 102. Hence, an unseparated sample introduced in the sample separation medium 112 can be separated in arrow X direction in FIGS. 1 and 2.

### (Unseparated Sample)

The unseparated sample is a sample that is not previously separated by electrophoresis or the like, and is separated by electrophoresis using the cassette for electrophoresis according to this embodiment. A method of introducing the unseparated sample into the porous member 132 is described later.

### (Sample Separation Unit)

Next, individual components of the sample separation unit 110 are described with reference to FIG. 3. In FIG. 3, part (a) is a perspective view schematically showing a configuration of the sample separation unit according to the embodiment of the invention, and part (b) is a perspective view schematically showing the configuration of the sample separation unit when an auxiliary tool is removed.

As shown in FIG. 3, the sample separation unit 110 is formed by stacking the sample separation medium support plate 111, the sample separation medium 112, the sample separation medium support plate 113, and the auxiliary tool 120 in that order. Also, the auxiliary tool 120 has through holes 121 and 122. The through holes are each provided to allow the porous member 132 and the pushing tool 131 to be inserted to the sample separation medium 112. By using a known adhesive or a known bonding method, the sample separation medium support plate 113 may be bonded with the auxiliary tool 120.

### (Sample Separation Medium)

The sample separation medium 112 is a medium that separates various samples in accordance with their properties by introducing an unseparated sample and carrying out electrophoresis.

The sample separation medium 112 is sandwiched between the sample separation medium support plates 111 and 113 (described later). Alternatively, the sample separation medium 112 may be formed in a space defined by the sample separation medium support plates 111 and 113 and spacers. Still alternatively, the sample separation medium 112 may be previously formed, moved to the space, and fixed. For example, if the sample separation medium 112 is an acrylamide gel, the acrylamide gel may be formed by pouring an acrylamide solution into the space and polymerizing the acrylamide. Alternatively, a formed acrylamide gel may be moved to the space and fixed.

The sample separation medium 112 is not particularly limited as long as a medium allows a sample to be introduced and separated; however, for example, the medium is preferably a gel. The gel may be, for example, a product that is gelled by using a gelling agent selected from a group consisting of polyacrylamide, agarose, agar-agar, and starch. Also, an agarose gel or a polyacrylamide gel is frequently used for the gel.

### (Sample Separation Medium Support Plate)

The sample separation medium support plates 111 and 113 are support plates that sandwich the sample separation medium 112 between both support plates. The sample separation medium support plate 111 is arranged below the sample separation medium 112. The sample separation medium support plate 113 is arranged above the sample separation medium 112. The sample separation medium support plate 113 is shorter than the sample separation medium support plate 111 in arrow X direction in FIGS. 1 and 2. Hence, a portion of the sample separation medium 112 is exposed from the sample separation medium support plate 113. The sample separation medium 112 that is not exposed contacts the sample separation medium support plate 113, and the sample separation medium 112 that is exposed is covered with the auxiliary tool 120.

The material of the sample separation medium support plates 111 and 113 may preferably use an insulator. Accordingly, the sample separation medium can be housed in the insulator, and electrophoresis can be carried out like normal slab electrophoresis or the like. As the insulator, for example, resin, such as, acrylic resin, polystylene, or polyethylene terephthalate; glass; or ceramic may be used, so that the support plate can be appropriately formed. The sample separation medium support plates 111 and 113 are bonded through spacers (not shown) arranged at both sides of the sample separation medium 112, and can house the sample separation medium 112.

### (Auxiliary Tool)

The auxiliary tool 120 is fitted to the sample separation medium support plate 113, and covers the exposed portion of the sample separation medium 112 exposed from the sample separation medium support plate 113. While the auxiliary tool 120 has the through holes 121 and 122, the size of each through hole may be any size as long as the porous member 132 and the pushing tool 131 can be inserted to the sample separation medium 112. The number of through holes is not particularly limited.

The upper surface of the sample separation medium 112 is exposed at portions provided with the through holes 121 and 122. The through holes 121 and 122 of the auxiliary tool 120 and the upper surface of the sample separation medium 112 form groove portions. By inserting the porous member 132 containing the unseparated sample and the pushing tool 131 into the corresponding groove portion, the unseparated sample can be introduced into the sample separation medium 112.

The material forming the auxiliary tool 120 may be, for example, resin, such as, acrylic resin, polystylene, or polyethylene terephthalate; glass; or ceramic. By using such a material, the auxiliary tool 120 used for electrophoresis can be appropriately formed.

### (Pushing Tool)

The pushing tool 131 is a tool used for pressing the porous member 132 or the sample separation medium 112 so that the porous member 132 is pushed into the sample separation medium 112. The pushing tool 131 is preferably formed of a hard material. The material of the pushing tool 131 may be, for example, resin, such as, acrylic resin, polystylene, polyethylene terephthalate, or epoxy resin; glass; or ceramic.

### (Porous Member)

The porous member 132 contains an unseparated sample and contacts the sample separation medium 112, so that the unseparated sample is moved to the sample separation medium 112.

The porous member 132 is not particularly limited as long as the porous member 132 is a member that can contain an unseparated sample and introduce the sample into the sample separation medium 112. However, the porous member 132 may be a substance, such as resin, filter paper, an agarose gel, or a glass filter. As the resin, for example, epoxy resin, acrylic resin, or the like, may be preferably used although the resin is not limited to these examples. Also, the form of the resin may be preferably, for example, a filter form having through holes. That is, the resin used for the porous member 132 may be, for example, a resin filter. As long as such a substance is used, a sample can be appropriately introduced into the sample separation medium 112. Even if the substance is inserted into the sample separation medium 112, the substance hardly affects electrophoresis.

The porous member 132 is more preferably hydrophilized. By hydrophilizing the porous member 132, a sample solution containing an unseparated sample can be easily introduced into the porous member 132.

The porous member 132 made of, for example, epoxy resin, acrylic resin, glass filter, or the like, can be hydrophilized by a method of, for example, corona discharge processing, ozone radiation, plasma polymerization, primer processing, or the like. It is to be noted that since the porous member 132 made of filter paper, an agarose gel, or the like, is hydrophilic hydrophilization is not needed.

The porous member 132 containing an unseparated sample and the pushing tool 131 may be separate members or may be bonded. The porous member 132 and the pushing tool 131 may be bonded by a known bonding method, for example, by using a double-sided adhesive tape or the like.

### (Variations of Pushing Tool and Porous Member)

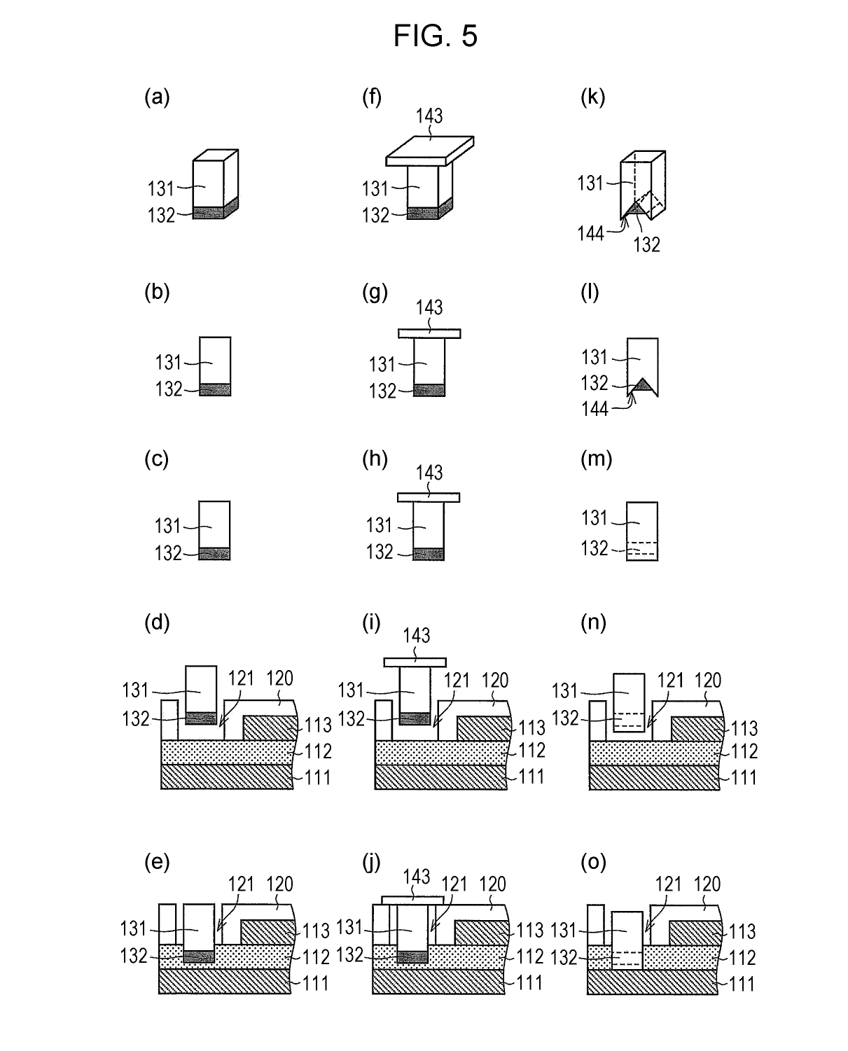

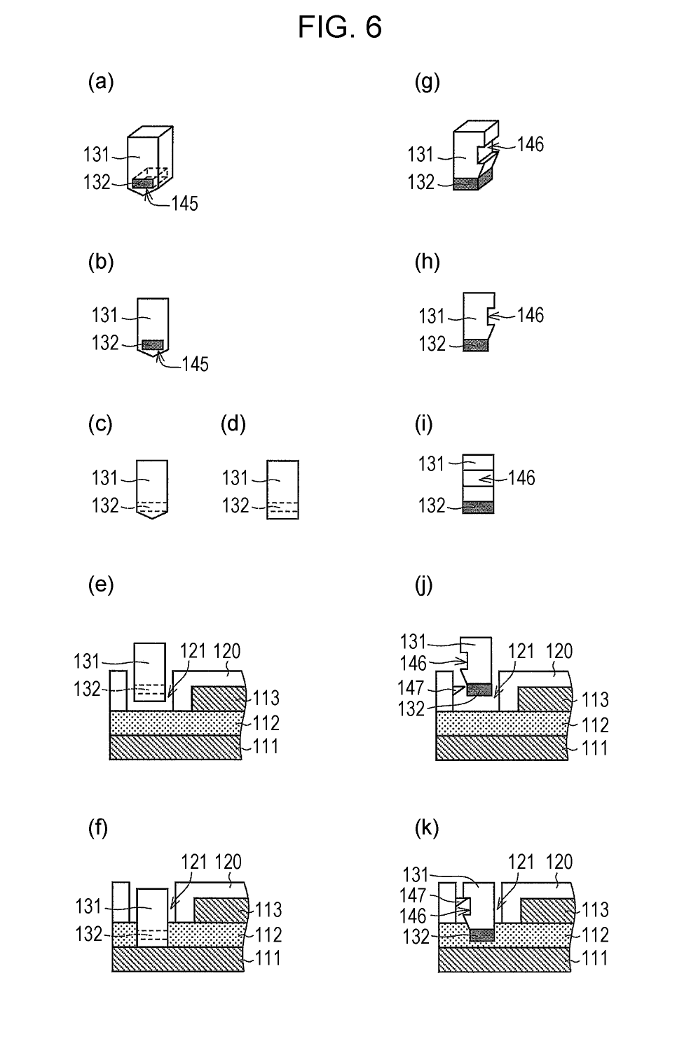

Variations of the pushing tool 131 and the porous member 132 are described below with reference to FIGS. 5 and 6. FIGS. 5 and 6 provide enlarged views each showing a variation of a pushing tool and a porous member containing an unseparated sample according to the embodiment of the invention. To be more specific, parts (b), (g), and (l) in FIG. 5, and parts (b) and (h) in FIG. 6 are front views of parts (a), (f), and (k) in FIG. 5, and parts (a) and (g) in FIG. 6, respectively. Parts (c), (h), and (m) in FIG. 5, and parts (c, d) and (i) in FIG. 6 are side views of parts (a), (f), and (k) in FIG. 5, and parts (a) and (g) in FIG. 6, respectively. Also, parts (d), (i), and (n) in FIG. 5, and parts (e) and (j) in FIG. 6 are each a cross-sectional view before the porous member 132 is pushed into the sample separation medium 112. Parts (e), (j), and (o) in FIG. 5, and parts (f) and (k) in FIG. 6 are each a cross-sectional view after the porous member 132 is pushed into the sample separation medium 112.

In FIG. 5, parts (a) to (e) each show a basic pushing tool 131 and a basic porous member 132 containing an unseparated sample. The porous member 132 does not have to be bonded with the pushing tool 131. However, as illustrated, if the porous member 132 is bonded with the pushing tool, it is easier to insert the porous member 132 and the pushing tool 131 into the through hole 121, 122.

In FIG. 5, parts (f) to (j) each show a modification of the basic pushing tool 131 and the basic porous member 132. Referring to the illustrations, the pushing tool 131 has a contact portion (second contact portion) 143 with a larger width than the width of the through hole 121, on an end portion at a side where the porous member 132 is not bonded. Hence, as shown in parts (i) and (j) in FIG. 5, when the pushing tool 131 is inserted into the through hole 121 and pushes the porous member 132 into the sample separation medium 112, the contact portion 143 contacts the upper surface (first contact portion) of the auxiliary tool 120.

That is, even when the pushing tool 131 is strongly pushed into the sample separation medium 112, the contact portion 143 and the upper surface of the auxiliary tool 120 contact each other, and the movement of the porous member 132 in the sample separation medium 112 is stopped. Hence, the pushing length when the pushing tool 131 and the porous member 132 are pushed into the sample separation medium 112 can be normally constant. Accordingly, the pushing tool 131 and the porous member 132 are prevented from excessively entering the sample separation medium 112, and the result of electrophoresis of an unseparated sample can be prevented from being disordered. The pushing length can be predetermined by properly adjusting the depth of the through hole 121 and the length of the sample separation medium in a pushing direction of the porous member 132, as well as the shapes of the pushing tool 131 and the porous member 132.

As shown in parts (g) to (k) in FIG. 6, the pushing tool 131 may have a recessed shape (second contact portion) 146 at its side surface, and the through hole 121 may have a protruding shape (first contact portion) 147 at its side surface. Hence, as shown in parts (j) and (k) in FIG. 6, when the pushing tool 131 is inserted into the through hole 121 and pushes the porous member 132 into the sample separation medium 112, the recessed shape 146 contacts the protruding shape 147, and the movement of the porous member 132 in the sample separation medium 112 is stopped. Hence, the pushing length when the pushing tool 131 and the porous member 132 are pushed into the sample separation medium 112 can be normally constant similarly to the above-described case. Accordingly, the pushing tool 131 and the porous member 132 are prevented from excessively entering the sample separation medium 112, and the result of electrophoresis of an unseparated sample can be prevented from being disordered.

As shown in parts (k) to (o) in FIG. 5, a recessed portion (cut portion) 144 may be formed at a bottom surface (tip end portion of the pushing tool 131 at the sample separation medium 112 side) of the pushing tool 131, and the porous member 132 containing an unseparated sample may be arranged in the recessed portion 144. Hence, even if a time elapses before electrophoresis is carried out, the porous member 132 does not contact the sample separation medium 112 unless the porous member 132 is pushed into the sample separation medium 112. Accordingly, an unseparated sample can be prevented from diffusing into the sample separation medium 112 before the porous member 132 is pushed into the sample separation medium 112.

Further, when the pushing tool 131 is pushed into the sample separation medium 112, as shown in part (o) in FIG. 5, not the porous member 132 but the pushing tool 131 made of a hard material contacts the sample separation medium support plate 111. Hence, the porous member 132 containing an unseparated sample can be normally inserted at the same position of the sample separation medium 112.

As shown in parts (a) to (f) in FIG. 6, a penetrating portion (hollow portion) 145 may be formed at side surfaces of the pushing tool 131, and the porous member 132 containing an unseparated sample may be arranged in the penetrating portion 145. Hence, even if a time elapses before electrophoresis is carried out, the porous member 132 does not contact the sample separation medium 112 unless the porous member 132 is pushed into the sample separation medium 112.

Alternatively, instead of the penetrating portion, a recess for arranging the porous member 132 may be formed at a side surface of the pushing tool. Accordingly, as described above, an unseparated sample can be prevented from diffusing into the sample separation medium 112 before the porous member 132 containing the unseparated sample is pushed into the sample separation medium 112, and the porous member 132 can be normally inserted at the same position of the sample separation medium 112.

Further, as shown in parts (a) to (c) in FIG. 6, a sharp portion protruding toward the sample separation medium 112 may be formed at a bottom surface (tip end portion of the pushing tool 131 at the sample separation medium 112 side) of the pushing tool 131. Accordingly, since the sharp portion of the pushing tool 131 contacts the sample separation medium 112 in the case in which the pushing tool 131 presses the sample separation medium 112, gas such as the air can be prevented from entering the close contact surfaces of the sample separation medium 112 and the pushing tool 131.

### (Electrophoresis Method)

An electrophoresis method according to an embodiment of the invention is described below. An electrophoresis method according to the embodiment of the invention includes a pushing step of pushing the porous member 132 containing an unseparated sample or the sample separation medium 112 for separating the sample so that the porous member 132 is pushed into the sample separation medium 112; and an electrophoresis step of carrying out electrophoresis for the unseparated sample which has been moved from the pushed porous member 132 to the sample separation medium 112.

Also, the electrophoresis method according to this embodiment further includes, before the pushing step, an applying step of applying a sample solution to the through hole 121; and a sample introducing step of causing a porous member 133 not containing a sample to contain an unseparated sample. The above-mentioned respective steps are described below with reference to the drawings.

### (Sample Introducing Step)

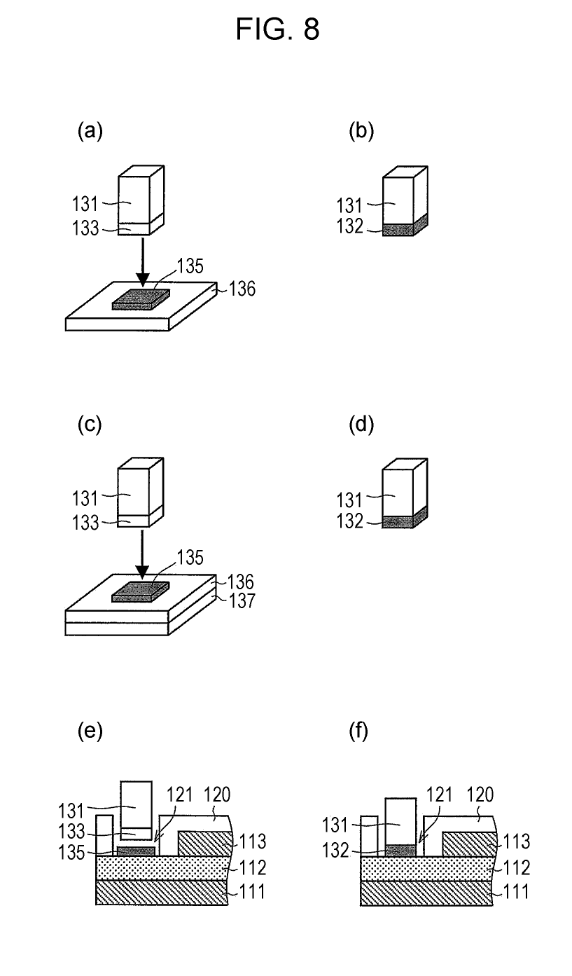

First, described with reference to FIG. 8 is the sample introducing step of introducing the unseparated sample into the porous member not containing the sample (hereinafter, also referred to as “porous member”) 133. FIG. 8 provides schematic illustrations each showing a method of introducing an unseparated sample into a porous member.

Parts (a) and (b) in FIG. 8 are illustrations showing a basic sample introducing method. First, a sample solution 135 is injected in a well arranged at a sample loading chip (sample introducing container) 136 (injecting step). The sample solution 135 contains an unseparated sample. Then, the porous member 133 such as filter paper not containing a sample is attached to a tip end of the pushing tool 131, the pushing tool 131 and the porous member 133 are inserted into the well with the sample solution 135 introduced, and the porous member 133 is dipped in the sample solution 135. Hence, the unseparated sample can be easily introduced into the porous member 133. The porous member 133 and the pushing tool 131 may be bonded by a known bonding method, for example, by using a double-sided adhesive tape.

Parts (c) and (d) in FIG. 8 are illustrations showing a modification of the sample introducing method. In this modification, agarose containing a SDS-PAGE loading buffer is previously put into the sample loading chip 136, and then the sample solution 135 is injected into the sample loading chip 136. Then, the sample loading chip 136 is arranged at a heat block 137, and heat is applied. When heated, the agarose is molten, and dissolved in the sample solution 135. Then, the porous member 133 attached to the tip end of the pushing tool 131 is dipped in the sample solution 135 having agarose dissolved therein. Accordingly, the unseparated sample and the dissolved agarose can be introduced into the porous member. Since the agarose is solidified within the porous member 133, the unseparated sample can be prevented from being moved to the outside from the porous member 133 before the pushing step (described later). Hence, the unseparated sample can be efficiently introduced into the porous member 133.

Parts (e) and (f) in FIG. 8 are illustrations each showing another modification of the sample introducing method. First, the sample solution 135 containing an unseparated sample is applied to the through hole 121 formed at the auxiliary tool 120 (applying step). The porous member 133 attached to the tip end of the pushing tool 131 is inserted and dipped in the sample solution 135. Accordingly, the unseparated sample can be easily introduced into the porous member 133, without provision of a mechanism (for example, sample loading chip 136) for introducing the unseparated sample into the porous member 133 as shown in parts (a) to (d) in FIG. 8 described above.

### (Pushing Step)

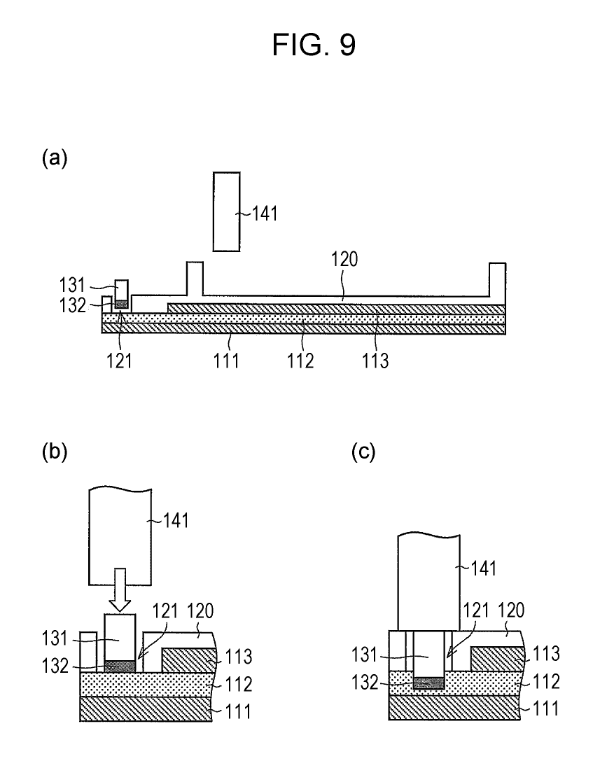

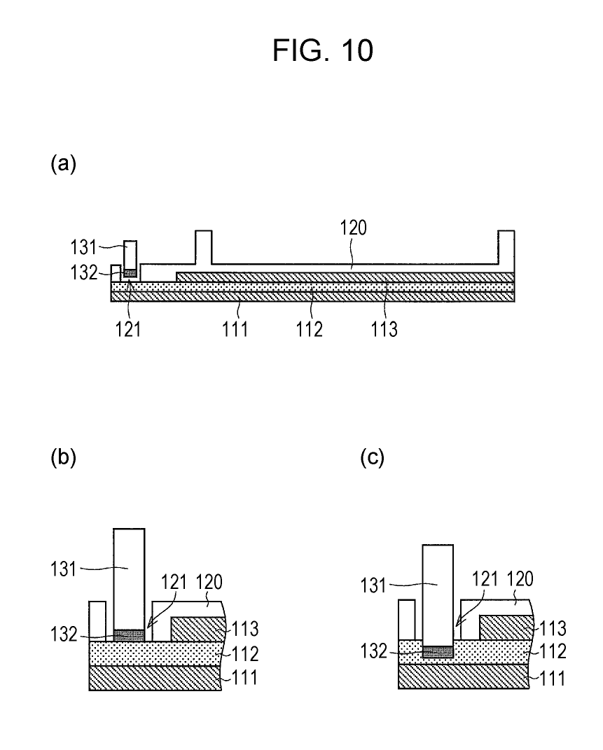

Next, the pushing step of pressing the porous member 132 or the sample separation medium 112 so that the porous member 132 containing the unseparated sample into the sample separation medium 112 is described with reference to FIGS. 9 and 10. FIG. 9 provides schematic illustrations each showing a method of pushing a porous member containing an unseparated sample into a sample separation medium according to an embodiment of the invention. FIG. 10 provides schematic illustrations each showing another method of pushing a porous member containing an unseparated sample into a sample separation medium.

First, as shown in part (a) in FIG. 9, the pushing tool 131 and the porous member 132 containing the unseparated sample are inserted into the through hole 121 of the auxiliary tool 120. Then, a pressing member 141 that presses the pushing tool 131 and the porous member 132 is moved to a position above the pushing tool 131.

As shown in parts (b) and (c) in FIG. 9, after the pressing member 141 is moved to the position above the pushing tool 131, the pressing member 141 presses the pushing tool 131 and the porous member 132, and pushes the porous member 132 containing the unseparated sample for the sample separation medium 112.

The pressing member 141 may have a configuration that transports the pushing tool 131 and the porous member 132 to the through hole 121 while the pressing member 141 supports the pushing tool 131.

Also, as shown in parts (a) and (b) in FIG. 10, without using the pressing member 141, the porous member 132 containing the unseparated sample and the pushing tool 131 may be transported and inserted into the through hole 121. Then, as shown in part (c) in FIG. 10, the pushing tool 131 and the porous member 132 may be pressed and the porous member 132 containing the unseparated sample may be pushed into the sample separation medium 112.

The operation of pushing the porous member 132 containing the unseparated sample for the sample separation medium 112 may be an automatic operation or a manual operation.

By pushing the porous member 132 into the sample separation medium 112, the unseparated sample is moved to the sample separation medium. Hence, the unseparated sample can be introduced to a position of the sample separation medium 112 at which the porous member 132 is inserted. Accordingly, the unseparated sample can be introduced to an optimal position of the sample separation medium 112.

Further, the unseparated sample can be easily introduced into the sample separation medium 112 without formation of a well in the sample separation medium 112.

### (Electrophoresis Step)

After the above-described pushing step, electrophoresis is carried out for the unseparated sample moved from the pushed porous member 132 to the sample separation medium 112 (electrophoresis step). By carrying out electrophoresis, a sample is separated on the basis of the property of the sample. As described above, since the unseparated sample can be prevented from diffusing into the sample separation medium 112, high resolution can be obtained during electrophoresis.

### Second Embodiment

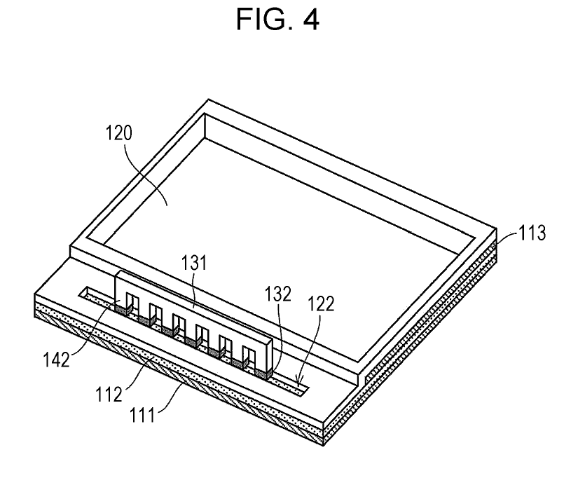

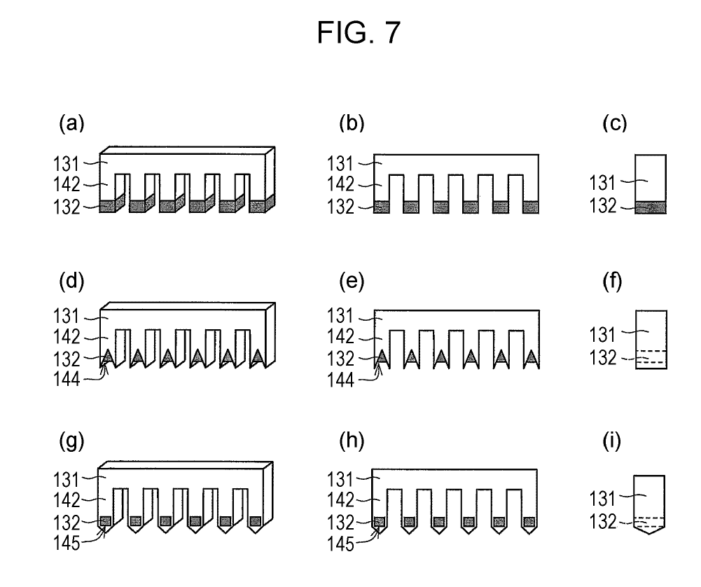

In the first embodiment, the pushing tool 131 presses the single porous member 132. In this embodiment, however, a configuration in which the pushing tool 131 includes a plurality of pushing portions 142 that respectively push a plurality of porous members 132 is described with reference to FIGS. 4 and 7. The same number is applied to the same member as that of the first embodiment, and its description is omitted. Also, the description for a method and the like similar to that of the first embodiment (electrophoresis method, sample introducing step, etc.) is omitted.

FIG. 4 is a cross-sectional view schematically showing a configuration of a cassette for electrophoresis according to another embodiment of the invention. FIG. 7 provides enlarged views each showing a variation of a pushing tool and a porous member containing an unseparated sample according to the other embodiment of the invention. Parts (b), (e), and (h) in FIG. 7 are front views of parts (a), (d), and (g) in FIG. 7, respectively. Parts (c), (f), and (i) in FIG. 7 are side views of parts (a), (d), and (g) in FIG. 7, respectively.

As shown in FIG. 4 and parts (a) to (c) in FIG. 7, the pushing tool 131 includes a plurality of pushing portions 142. Each pushing portion 142 is bonded with a porous member 132. Also, the auxiliary tool 120 has a through hole 122 that allows the pushing tool 131 and the plurality of porous members 132 to be inserted to the sample separation medium 112. Accordingly, the plurality of porous members 132 containing unseparated samples can be simultaneously pushed into the sample separation medium 112, and the samples in the plurality of porous members 132 can be simultaneously brought into electrophoresis.

In FIG. 7, parts (d) to (f) each show a modification of the pushing tool 131 and the porous member 132 shown in parts (a) to (c) in FIG. 7. Referring to the illustrations, the porous members 132 containing unseparated samples are arranged in recessed portions 144 respectively formed at bottom surfaces of the plurality of pushing portions 142 (tip end portions of the pushing portions 142 at the sample separation medium 112 side). Accordingly, advantages similar to those of the configuration shown in parts (k) to (o) in FIG. 5 according to the first embodiment are attained.

In FIG. 7, parts (g) to (i) each show another modification of the pushing tool 131 and the porous member 132 shown in parts (a) to (c) in FIG. 7. Referring to the illustrations, the porous members 132 containing unseparated samples are respectively arranged in penetrating portions (hollow portions) 145 respectively formed at side surfaces of the plurality of pushing portions 142. Accordingly, advantages similar to those of the configuration shown in parts (d) to (f) in FIG. 7 can be attained.

Further, as shown in parts (g) to (i) in FIG. 7, sharp portions protruding toward the sample separation medium 112 are respectively formed at bottom surfaces (tip end portions of the pushing portions 142 at the sample separation medium 112 side) of the plurality of pushing portions 142. Accordingly, advantages similar to those of the configuration shown in parts (a) to (c) in FIG. 6 according to the first embodiment are attained.

As other structure, there may be provided a structure, in which a plurality of pushing tools 131 and a plurality of porous members 132 containing unseparated samples shown in FIGS. 5 and 6 are continuously arranged.

The invention is not limited to the above-described embodiments, and may be modified in various ways within the scope described in the claims. That is, embodiments obtained by combining appropriately modified technical means within the scope described in the claims are also included in the technical scope of the invention.

### INDUSTRIAL APPLICABILITY

The cassette for electrophoresis according to the invention can be used in the manufacturing field of analysis equipment for various samples (in particular, biosepcimens).

### REFERENCE SIGNS LIST

100 cassette for electrophoresis
101 buffer cell
102 electrophoresis buffer solution reservoir
110 sample separation unit
111, 113 sample separation medium support plate (insulator)
112 sample separation medium
120 auxiliary tool
121, 122 through hole
131 pushing tool
132 porous member
133 porous member not containing sample
135 sample solution
136 sample loading chip (sample introducing container)
137 heat block
141 pressing member
142 pushing portion
143 contact portion (second contact portion)
144 recessed portion (cut portion)
145 penetrating portion (hollow portion)
146 recessed shape (second contact portion)
147 protruding shape (first contact portion)

1-15. (canceled)

16. A cassette for electrophoresis, comprising:
a porous member containing an unseparated sample;
a sample separation medium for separating the sample;
a pushing tool that presses the porous member or the sample separation medium so that the porous member is pushed into the sample separation medium; and
an auxiliary tool arranged on the sample separation medium and being in close contact with the sample separation medium,
wherein the auxiliary tool has a through hole that allows the porous member and the pushing tool to be inserted to the sample separation medium.

17. The cassette for electrophoresis according to claim 16, further comprising:
an insulator that houses the sample separation medium while a portion of an upper surface of the sample separation medium is exposed,
wherein the auxiliary tool is fitted to the insulator and is in close contact with the exposed portion of the sample separation medium.

18. The cassette for electrophoresis according to claim 16,
wherein the auxiliary tool includes a first contact portion,
wherein the pushing tool includes a second contact portion, and
wherein the first contact portion and the second contact portion contact each other and stop movement of the porous member in a case in which the porous member is pushed into the sample separation medium by a predetermined length.

19. The cassette for electrophoresis according to claim 16,
wherein a hollow portion is formed at side surfaces of the pushing tool, and
wherein the porous member is arranged in the hollow portion.

20. The cassette for electrophoresis according to claim 16, wherein a sharp portion protruding toward the sample separation medium is formed at a tip end portion of the pushing tool.

21. The cassette for electrophoresis according to claim 16, wherein the porous member is attached to a tip end portion of the pushing tool.

22. The cassette for electrophoresis according to claim 16, wherein the porous member is made of a substance selected from a group consisting of resin, filter paper, an agarose gel, and a glass filter.

23. The cassette for electrophoresis according to claim 16, wherein the porous member is hydrophilized.

24. The cassette for electrophoresis according to claim 16, wherein the sample separation medium is made of a gel.

25. The cassette for electrophoresis according to claim 16, comprising:
a plurality of the porous members,
wherein the pushing tool includes a plurality of pushing portions that respectively push the plurality of porous members into the sample separation medium.

26. An electrophoresis method, comprising:
a pushing step of pressing a porous member containing an unseparated sample or a sample separation medium for separating the unseparated sample by using a pushing tool so that the porous member is pushed into the sample separation medium;
an electrophoresis step of carrying out electrophoresis for the unseparated sample which has been moved from the pushed porous member to the sample separation medium;
an applying step of, while an auxiliary tool being in close contact with the sample separation medium and having a through hole that allows the porous member to be inserted to the sample separation medium is arranged on the sample separation medium, applying a sample solution containing the unseparated sample to the through hole before the pushing step; and
a sample introducing step of causing the porous member to contain the unseparated sample by inserting the porous member into the through hole applied with the sample solution after the applying step and before the pushing step.

27. An electrophoresis method, comprising:
a pushing step of pressing a porous member containing an unseparated sample or a sample separation medium for separating the unseparated sample by using a pushing tool so that the porous member is pushed into the sample separation medium;
an electrophoresis step of carrying out electrophoresis for the unseparated sample which has been moved from the pushed porous member to the sample separation medium;
an injecting step of injecting a sample solution containing the unseparated sample into a sample introducing container before the pushing step; and
a sample introducing step of causing the porous member to contain the unseparated sample by inserting the porous member into the sample introducing container containing the sample solution after the injecting step and before the pushing step.

28. The electrophoresis method according to claim 27,
wherein agarose is put into the sample introducing container in the injecting step, and
wherein the agarose in the sample introducing container is heated and molten in the sample introducing step.
